(19) United States
(12) Patent Application Publication
(10) Pub. No.: US 2011/0252439 A1
(43) Pub. Date: Oct. 13, 2011

(54) METHOD FOR PROVIDING MULTIMEDIA STREAMING SERVICE AND RELATED WIRELESS PACKET RELAY APPARATUS AND WIRELESS SET-TOP BOX

(76) Inventors: Chung-Chiu LAI, Zhubei City (TW); Ling-Chun Chen, Hsinchu City (TW); Wei-Tsan Wang, Zhongpu Township (TW)

(21) Appl. No.: 12/774,942

(22) Filed: May 6, 2010

(30) Foreign Application Priority Data
Apr. 8, 2010 (TW) 099110957

(51) Int. Cl. H04L 9/00; H04B 7/14; H04N 7/173

(52) U.S. Cl. 725/25; 370/315

(57) ABSTRACT

A wireless packet relay apparatus is disclosed including: an RF module for receiving a streaming service request from a wireless set-top box; a network interface; and a processing circuit for performing a predetermined network connection authentication with the wireless set-top box via the RF module; wherein the processing circuit transmits the streaming service request to a multimedia streaming server via the network interface if the streaming service request is received by the RF module within a predetermined period.

### BACKGROUND OF THE INVENTION

1. Field of the Invention

The present invention relates to technology for providing multimedia streaming services, and more particularly, to wireless packet relay apparatuses and wireless set-top boxes with enhanced connection security authentication mechanism.

2. Description of Related Art

Multimedia streaming service has become more and more popular as the Internet accessing bandwidth increases. When a user applies for a multimedia streaming service, the multimedia streaming service provider would provide the user with a dedicated set-top box in order to control the user's accessing right or subscribed programs.

Conventionally, the set-top box provided by the multimedia streaming service provider requires accessing the Internet via physical cable, which is usually troublesome in wiring or interior decoration.

Replacing the conventional set-top box with a combination of a wireless AP and a wireless set-top box may be more convenient for the user, but the multimedia streaming service provider may thus encounter problems in connection security authentication issues. If it is unable to assure whether a wireless set-top box is provided or authorized by the multimedia streaming service provider, a malicious user may have chance to utilize an invalid/unauthorized set-top box to access unsubscribe multimedia streaming contents via a valid wireless AP of the multimedia streaming service provider, which could cause considerable loss to the multimedia streaming service provider's business interest.

### SUMMARY OF THE INVENTION

In view of the foregoing, it can be appreciated that a substantial need exists for methods and apparatuses that can mitigate or reduce the security concerns when providing multimedia streaming service.

An exemplary embodiment of a wireless packet relay apparatus is disclosed comprising: an RF module for receiving a streaming service request from a wireless set-top box; a network interface; and a processing circuit for performing a predetermined network connection authentication with the wireless set-top box via the RF module; wherein the processing circuit transmits the streaming service request to a multimedia streaming server via the network interface if the streaming service request is received by the RF module within a predetermined period.

An exemplary embodiment of a wireless set-top box is disclosed comprising: an RF module; and a control circuit for performing a predetermined network connection authentication with a wireless packet relay apparatus via the RF module, and for transmitting a streaming service request to the wireless packet relay apparatus via the RF module within a predetermined period.

An exemplary embodiment of a method for providing a multimedia streaming service, comprising: conducting a predetermined network connection authentication for a wireless set-top box; receiving a streaming service request from the wireless set-top box; and denying the streaming service request if the streaming service request is not received within a predetermined period.

It is to be understood that both the foregoing general description and the following detailed description are exemplary and explanatory only and are not restrictive of the invention, as claimed.

### BRIEF DESCRIPTION OF THE DRAWINGS

FIG. 1 is a simplified schematic diagram of a multimedia streaming service transmission system in accordance with an exemplary embodiment.

FIG. 2 is a simplified functional block diagram of the wireless packet relay apparatus of FIG. 1 according to an exemplary embodiment.

FIG. 3 is a simplified functional block diagram of the wireless set-top box of FIG. 1 according to an exemplary embodiment.

FIG. 4 is a flowchart illustrating a method for providing multimedia streaming service in accordance with an exemplary embodiment.

### DETAILED DESCRIPTION

Reference will now be made in detail to exemplary embodiments of the invention, which are illustrated in the accompanying drawings. The same reference numbers may be used throughout the drawings to refer to the same or like parts or operations. Certain terms are used throughout the description and following claims to refer to particular components. As one skilled in the art will appreciate, vendors may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . .”

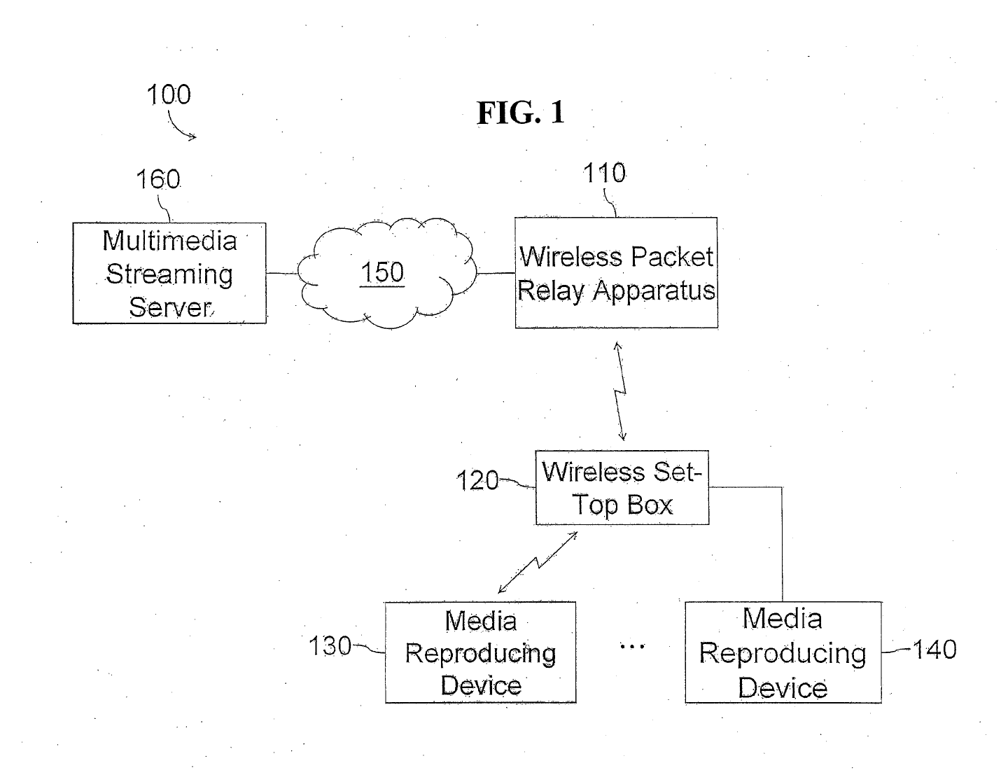

Please refer to FIG. 1, which shows a simplified schematic diagram of a multimedia streaming service transmission system 100 in accordance with an exemplary embodiment. The multimedia streaming service transmission system 100 comprises a wireless packet relay apparatus 110 and a wireless set-top box 120. The wireless packet relay apparatus 110 communicates with a multimedia streaming server 160 of a multimedia streaming service provider (such as an Internet Service Provider or cable TV vendor) via the Internet 150 to access the multimedia streaming service subscribed by the user. In implementations, the wireless packet relay apparatus 110 may be designed to have a built-in router function, or may be designed to communicate with the Internet 150 via an external router.

When receives multimedia streaming data from the multimedia streaming server 160, the wireless packet relay apparatus 110 relays the received multimedia streaming data to the wireless set-top box 120 using a wireless transmission approach. The wireless set-top box 120 then transmits the received multimedia streaming data to one or more media reproducing devices (media reproducing devices 130 and 140 are shown in FIG. 1 as examples), such as computers, televisions, or other reproducing devices, using wired and wireless transmission approaches.

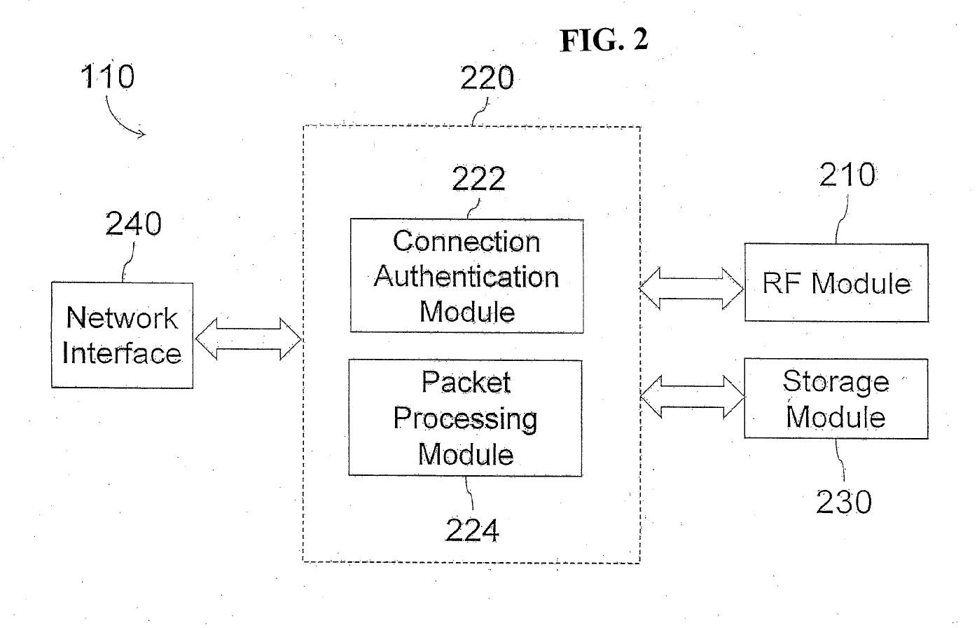

FIG. 2 shows a simplified functional block diagram of the wireless packet relay apparatus 110 according to an exemplary embodiment. In this embodiment, the wireless packet relay apparatus 110 comprises an RF module 210, a processing circuit 220, a storage module 230, and a network interface 240. As shown in FIG. 2, the processing circuit 220 comprises a connection authentication module 222 and a packet processing module 224.

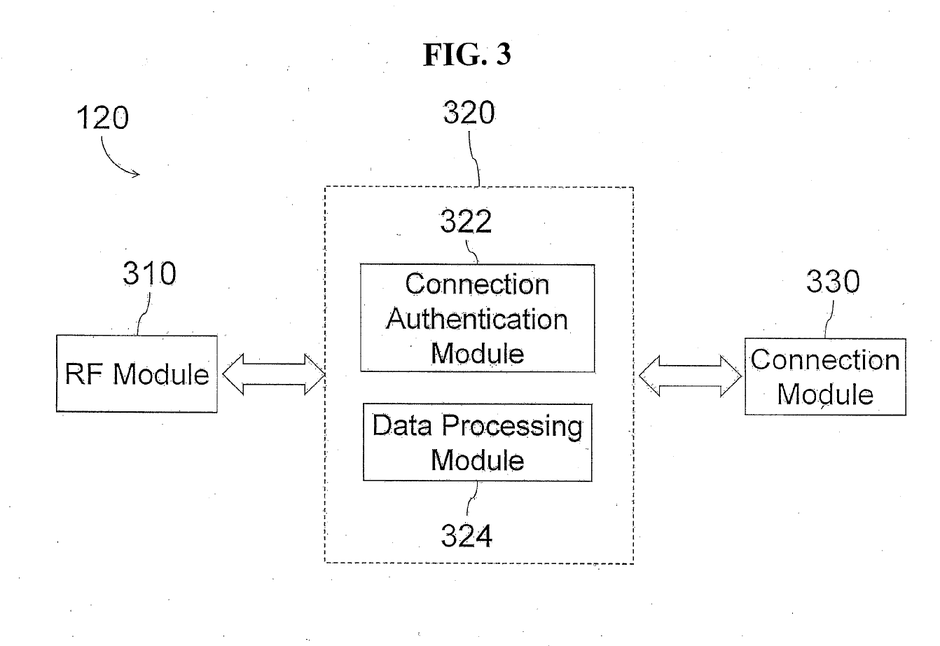

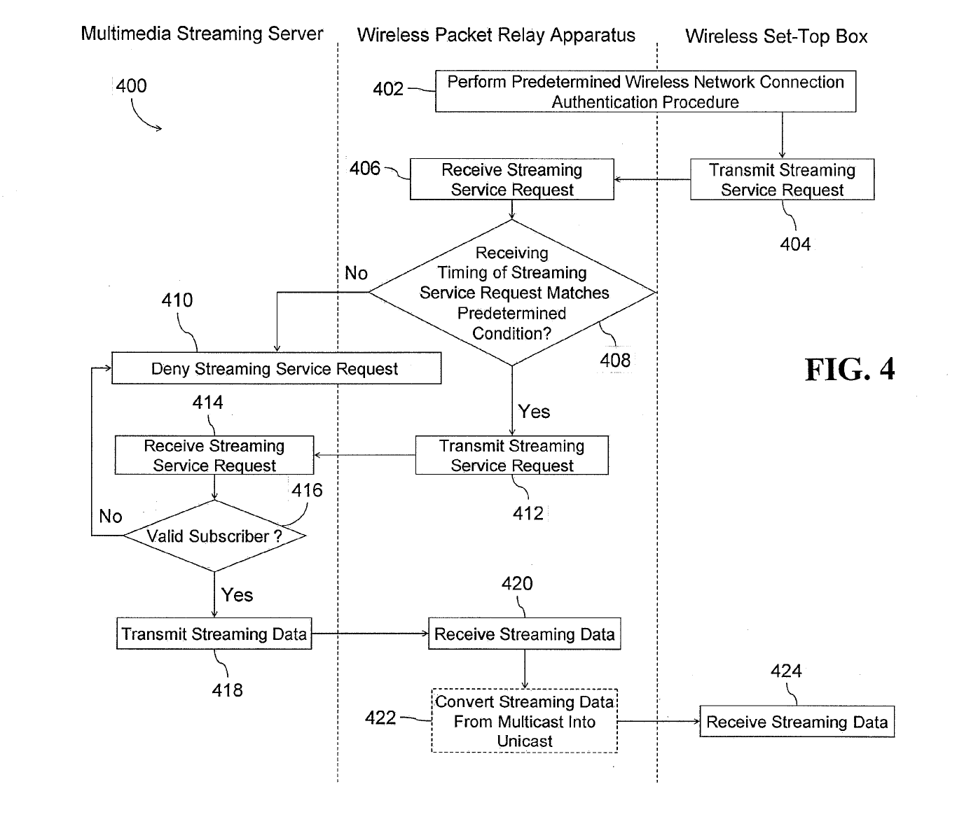

FIG. 3 shows a simplified functional block diagram of the wireless set-top box 120 according to an exemplary embodiment. In this embodiment, the wireless set-top box 120 comprises an RF module 310, a control circuit 320, and a connection module 330, wherein the control circuit 320 comprises a connection authentication module 322 and a data processing module 324. The operations of the multimedia streaming service transmission system 100 will be further described with reference to FIG. 4.

FIG. 4 shows a flowchart 400 of a method for providing multimedia streaming service in accordance with an exemplary embodiment.

When a user utilizes a remote control or other controlling approaches to command the wireless set-top box 120 or the wireless packet relay apparatus 110 to initiate a multimedia streaming service, the wireless set-top box 120 and the wireless packet relay apparatus 110 conduct an operation 402 to perform a predetermined wireless network connection authentication procedure through the connection authentication module 322 and the connection authentication module 222. In practice, the predetermined network connection authentication may be implemented by any standard wireless network connection authentication mechanism, such as Wi-Fi protected setup (WPS) or the like. If the predetermined network connection authentication is not passed, the connection authentication module 222 of the wireless packet relay apparatus 110 determines that the wireless set-top box 120 is not a valid set-top box provided or authorized by the multimedia streaming service provider, and would therefore deny the subsequent streaming service request from the wireless set-top box 120.

If the predetermined network connection authentication is passed, the connection authentication module 222 of the wireless packet relay apparatus 110 transmits an encryption key to the wireless set-top box 120 via the RF module 210. When receives the encryption key, the connection authentication module 322 of the wireless set-top box 120 performs an operation 404 within a predetermined period to transmit an streaming service request to the wireless packet relay apparatus 110 via the RF module 310. In implementations, the streaming service request may be transmitted in the form of an Internet Group Management Protocol (IGMP) packet or a Multicast Listener Discovery (MLD) packet.

In an operation 406, the RF module 210 of the wireless packet relay apparatus 110 receives the streaming service request transmitted from the wireless set-top box 120.

In an operation 408, the connection authentication module 222 of the wireless packet relay apparatus 110 checks whether the streaming service request is received within a predetermined period. The predetermined period may be configured based on the connection security strength requirement of the multimedia streaming service provider. In one embodiment, for example, it is configured that the predetermined period is within two hours from the beginning of conducting the predetermined network connection authentication. In another embodiment, it is configured that the predetermined period is within ten minutes from the beginning of conducting the predetermined network connection authentication. In another embodiment, it is configured that the predetermined period is within ten seconds after the predetermined network connection authentication is passed. In another embodiment, it is configured that the predetermined period is within five seconds after the predetermined network connection authentication is passed. In another embodiment, it is configured that the predetermined period is in the fifth second to the tenth second after the predetermined network connection authentication is passed. In yet another embodiment, it is configured that the predetermined period is in the first second to the third second after the predetermined network connection authentication is passed.

In implementations, the predetermined period may be measured and configured on the basis of real time as described in the above embodiments. Alternatively, the predetermined period may be measured and configured on the basis of required time for the wireless packet relay apparatus 110 to receive a certain number of packets transmitted from the wireless set-top box 120. In one embodiment, for example, it is configured that the predetermined period is in a period of receiving 3,000 packets from the beginning of conducting the predetermined network connection authentication. In another embodiment, it is configured that the predetermined period is in a period of receiving 1,000 packets from the beginning of conducting the predetermined network connection authentication. In another embodiment, it is configured that the predetermined period is in a period of receiving 50 packets after the predetermined network connection authentication is passed. In another embodiment, it is configured that the predetermined period is in a period of receiving 2 packets after the predetermined network connection authentication is passed. In another embodiment, it is configured that the predetermined period is in a period of receiving the fifth to fifteen packets after the predetermined network connection authentication is passed. In yet another embodiment, it is configured that the predetermined period is in a period of receiving the first to third packets after the predetermined network connection authentication is passed.

If the time point at which the wireless packet relay apparatus 110 receives the streaming service request is not within the predetermined period, the connection authentication module 222 determines that the wireless set-top box 120 is not a valid set-top box provided or authorized by the multimedia streaming service provider, and would therefore perform an operation 410 to deny the streaming service request of the wireless set-top box 120.

If the time point at which the wireless packet relay apparatus 110 receives the streaming service request is within the predetermined period, the connection authentication module 222 determines that the wireless set-top box 120 is a valid set-top box provided or authorized by the multimedia streaming service provider, and performs an operation 412 to utilize the network interface 240 to transmit the streaming service request of the wireless set-top box 120 to the multimedia streaming server 160 via the Internet 150.

In an operation 414, the multimedia streaming server 160 receives the streaming service request transmitted from the wireless packet relay apparatus 110.

The multimedia streaming server 160 then proceeds to an operation 416 to verify whether the received streaming service request corresponds to a valid multimedia streaming service subscriber. If the received streaming service request does not correspond to any valid service subscriber, the multimedia streaming server 160 proceeds to the operation 410 to deny the streaming service request of the wireless set-top box 120. If the received streaming service request corresponds to a valid service subscriber, the multimedia streaming server 160 performs an operation 418 to transmit corresponding streaming data in multicast format to the wireless packet relay apparatus 110 via the Internet.

In an operation 420, the packet processing module 224 of the wireless packet relay apparatus 110 receives the streaming data in multicast format via the network interface 240.

In implementations, the packet processing module 224 may forward the streaming data in multicast format to the wireless set-top box 120 via the RF module 210 using a wireless transmission approach.

In a preferred embodiment, the packet processing module 224 performs an operation 422 to convert the received streaming data in multicast format into unicast format, and then transmit the streaming data in unicast format to the wireless set-top box 120 via the RF module 210. Unicast transmission could use re-transmission mechanism to reduce the problem of packet loss. Thus, the quality of multimedia streaming service received by the wireless set-top box 120 can be greatly improved by converting the multimedia streaming data in multicast format transmitted from the multimedia streaming server 160 into unicast format and then transmitting to the wireless set-top box 120. In implementations, the packet processing module 224 may store packet data for use in re-transmission in the storage module 230.

In an operation 424, the data processing module 324 of the wireless set-top box 120 receives the streaming data from the wireless packet relay apparatus 110, and forwards the received multimedia streaming service content to one or more corresponding media reproducing devices, such as 130 and 140, via the connection module 330 using wired or wireless transmission approaches.

As can be seen from the foregoing descriptions, the wireless packet relay apparatus 110 and the wireless set-top box 120 not only conduct a predetermined wireless network connection authentication mechanism (such as WPS), but also employ additional timing examination mechanism to check the transmitting timing/receiving timing of the streaming service request so as to strengthen the connection security authentication mechanism between the wireless packet relay apparatus 110 and the wireless set-top box 120. As described previously, the length of the predetermined period mentioned in the operation 408 may be configured based on the requirement of the multimedia streaming service provider. As a result, only the wireless packet relay apparatus 110 and the wireless set-top box 120 provided or authorized by the multimedia streaming service provider can be aware of the restriction of the transmitting timing/receiving timing of the streaming service request. Therefore, malicious users are difficult or not able to utilize other unauthorized set-top box to deceive the wireless packet relay apparatus 110 and get the right to wirelessly access to the wireless packet relay apparatus 110.

In general, the shorter the length of the predetermined period, the higher the strength of connection security between the wireless packet relay apparatus 110 and the wireless set-top box 120. This is because it is more difficult for other unauthorized set-top boxes to pass the connection security examination as the length of the predetermined period decreases.

In other words, the operations 402 through 416 of the flowchart 400 can be regarded as a method of enhanced wireless network connection security authentication.

In implementations, the functions of the connection authentication module 222 and the packet processing module 224 in the wireless packet relay apparatus 110 may be realized by software approaches. Similarly, the functions of the connection authentication module 322 and the data processing module 324 in the wireless set-top box 120 can also be realized by software approaches.

With the collaboration of the wireless packet relay apparatus 110 and the wireless set-top box 120 described above, the traditional problem of physical wiring can be resolved, thereby providing more convenience to the users while reducing the information security concerns of the multimedia streaming service providers.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A wireless packet relay apparatus comprising:
an RF module for receiving a streaming service request from a wireless set-top box;
a network interface; and
a processing circuit for performing a predetermined network connection authentication with the wireless set-top box via the RF module;
wherein the processing circuit transmits the streaming service request to a multimedia streaming server via the network interface if the streaming service request is received by the RF module within a predetermined period.

2. The wireless packet relay apparatus of claim 1, wherein the processing circuit converts multicast packets transmitted from the multimedia streaming server into unicast packets, and transmits the unicast packets to the wireless set-top box via the RF module.

3. The wireless packet relay apparatus of claim 1, wherein the predetermined period is:
within two hours from the beginning of conducting the predetermined network connection authentication;
within ten minutes from the beginning of conducting the predetermined network connection authentication;
within ten seconds after the predetermined network connection authentication is passed;
within five seconds after the predetermined network connection authentication is passed;
in the fifth second to the tenth second after the predetermined network connection authentication is passed; or
in the first second to the third second after the predetermined network connection authentication is passed.

4. The wireless packet relay apparatus of claim 1, wherein the predetermined period is:
in a period of receiving 3,000 packets from the beginning of conducting the predetermined network connection authentication;
in a period of receiving 1,000 packets from the beginning of conducting the predetermined network connection authentication;
in a period of receiving 50 packets after the predetermined network connection authentication is passed;
in a period of receiving 2 packets after the predetermined network connection authentication is passed;
in a period of receiving the fifth to fifteen packets after the predetermined network connection authentication is passed; or
in a period of receiving the first to third packets after the predetermined network connection authentication is passed.

5. A wireless set-top box comprising:
an RF module; and
a control circuit for performing a predetermined network connection authentication with a wireless packet relay apparatus via the RF module, and transmitting a streaming service request to the wireless packet relay apparatus via the RF module within a predetermined period.

6. The wireless set-top box of claim 5, further comprises:
a connection module, coupled with the control circuit and one or more media reproducing devices, for transmitting multicast packets or unicast packets from the wireless packet relay apparatus to a corresponding media reproducing device.

7. The wireless set-top box of claim 5, wherein the predetermined period is:
within two hours from the beginning of conducting the predetermined network connection authentication;
within ten minutes from the beginning of conducting the predetermined network connection authentication;
within ten seconds after the predetermined network connection authentication is passed;
within five seconds after the predetermined network connection authentication is passed;
in the fifth second to the tenth second after the predetermined network connection authentication is passed; or
in the first second to the third second after the predetermined network connection authentication is passed.

8. The wireless set-top box of claim 5, wherein the predetermined period is:
in a period of transmitting 3,000 packets to the wireless packet relay apparatus from the beginning of conducting the predetermined network connection authentication;
in a period of transmitting 1,000 packets to the wireless packet relay apparatus from the beginning of conducting the predetermined network connection authentication;
in a period of transmitting 50 packets to the wireless packet relay apparatus after the predetermined network connection authentication is passed;
in a period of transmitting 2 packets to the wireless packet relay apparatus after the predetermined network connection authentication is passed;
in a period of transmitting the fifth to fifteen packets to the wireless packet relay apparatus after the predetermined network connection authentication is passed; or
in a period of transmitting the first to third packets to the wireless packet relay apparatus after the predetermined network connection authentication is passed.

9. A method for providing a multimedia streaming service, comprising:
conducting a predetermined network connection authentication for a wireless set-top box;
receiving a streaming service request from the wireless set-top box; and
denying the streaming service request if the streaming service request is not received within a predetermined period.

10. The method of claim 9, further comprising:
converting multicast packets transmitted from a multimedia streaming server into unicast packets; and
transmitting the unicast packets to the wireless set-top box.

11. The method of claim 9, wherein the predetermined period is:
within two hours from the beginning of conducting the predetermined network connection authentication;
within ten minutes from the beginning of conducting the predetermined network connection authentication;
within ten seconds after the predetermined network connection authentication is passed;
within five seconds after the predetermined network connection authentication is passed;
in the fifth second to the tenth second after the predetermined network connection authentication is passed; or
in the first second to the third second after the predetermined network connection authentication is passed.

12. The method of claim 9, wherein the predetermined period is:
in a period of receiving 3,000 packets transmitted from the wireless set-top box since the beginning of conducting the predetermined network connection authentication;
in a period of receiving 1,000 packets transmitted from the wireless set-top box since the beginning of conducting the predetermined network connection authentication;
in a period of receiving 50 packets transmitted from the wireless set-top box after the predetermined network connection authentication is passed;
in a period of receiving 2 packets transmitted from the wireless set-top box after the predetermined network connection authentication is passed;
in a period of receiving the fifth to fifteen packets transmitted from the wireless set-top box after the predetermined network connection authentication is passed; or
in a period of receiving the first to third packets transmitted from the wireless set-top box after the predetermined network connection authentication is passed.
